(19) United States
(12) Patent Application Publication
(10) Pub. No.: US 2015/0357075 A1
(43) Pub. Date: Dec. 10, 2015

(54) METHODS AND DEVICES FOR IN SITU SYNTHESIS OF METAL OXIDES IN CARBON NANOTUBE ARRAYS

(71) Applicants: California Institute of Technology, (US); The Regents of the University of California, (US)

(72) Inventors: Chiara DARAIO, Pasadena, CA (US); Daniel E. MORSE, Santa Barbara, CA (US); Jordan R. RANEY, Pasadena, CA (US); Hong-Li ZHANG, Goleta, CA (US)

(73) Assignees: The Regents of the University of California, Oakland, CA (US); California Institute of Technology, Pasadena, CA (US)

(21) Appl. No.: 13/870,954

(22) Filed: Apr. 25, 2013

Related U.S. Application Data
(60) Provisional application No. 61/639,747, filed on Apr. 27, 2012.

(51) Int. Cl. H01B 1/04

(52) U.S. Cl. CPC H01B 1/04

(57) ABSTRACT

A method for controlling microstructural and nanostructural arrangement of nominally-aligned arrays of carbon nanotubes (CNTs) is disclosed. The method comprises synthesizing metal oxide particles in situ in nominally-aligned arrays of carbon nanotubes (CNTs) after synthesis of CNTs. The particles can be SnO₂ particles or MnO₂ particles. A foam structure is further disclosed. The foam structure comprises nominally-aligned arrays of carbon nanotubes (CNTs) and a plurality of metal oxide particles associated with the nominally-aligned arrays of carbon nanotubes (CNTs). The CNTs have an original crystalline structure as grown and the CNTs with the metal oxide particles have a crystalline structure equal to the crystalline structure of the CNTs as grown.

### CROSS REFERENCE TO RELATED APPLICATIONS

The present application claims priority to U.S. Provisional Application No. 61/639,747, filed on Apr. 27, 2012, which is incorporated herein by reference in its entirety. The present application may be related to U.S. patent application Ser. No. 13/491,014, filed on Jun. 7, 2012, and U.S. patent application Ser. No. 13/254,402 filed on Mar. 2, 2010, each of which is incorporated herein by reference in its entirety. The present application can also be related to U.S. application Ser. No. 13/866,596, entitled “Multilayer Foam Structures Of Nominally-Aligned Carbon Nanotubes (CNTs)”, filed on Apr. 19, 2013, and U.S. application Ser. No. 13/868,952, entitled “Method For Controlling Microstructural Arrangement Of Nominally-Aligned Arrays Of Carbon Nanotubes” filed on Apr. 23, 2013, by Chiara Daraio, Abha Misra and Jordan R Raney, each of which is incorporated herein by reference in its entirety.

### STATEMENT OF GOVERNMENT GRANT

This invention was made with government support under W911NF-09-D-0001 awarded by the Army Research Office. The government has certain rights in the invention.

### FIELD

The present disclosure relates to methods and devices for in situ synthesis of metal oxides in carbon nanotube arrays. The present disclosure further relates to carbon nanotubes foams with controllable mechanical properties.

### BACKGROUND

Nominally-aligned arrays of carbon nanotubes (CNTs) are known to behave as low-density energy dissipative foams under compression. The material can be readily synthesized using standard thermal chemical vapor deposition techniques, resulting in a foam-like bulk material consisting of trillions of CNTs per square centimeter. However, these systems have remained largely unused in practical applications due to large variations in properties that result from the synthesis process.

### SUMMARY

According to a first aspect of the present disclosure, a method for controlling microstructural arrangement of nominally-aligned arrays of carbon nanotubes (CNTs) is provided. The method comprises modifying or controlling mechanical response of CNT arrays after synthesis of CNTs by synthesizing particles in situ in the nominally-aligned arrays of carbon nanotubes (CNTs).

According to a second aspect of the present disclosure, a method for controlling microstructural arrangement of nominally-aligned arrays of carbon nanotubes (CNTs) is provided where the CNTs have an ordered structure as grown. The method comprises modifying mechanical response of arrays of CNTs after synthesis of CNTs by associating a plurality of particles to the arrays of CNTs, where the arrangement of CNTs with the particles is an arrangement ordered like or equally to the ordered structure of the CNTs as grown.

According to a third aspect of the disclosure, a foam structure comprising nominally-aligned arrays of carbon nanotubes (CNTs) is provided. The foam structure further comprises a plurality of particles associated to the nominally-aligned arrays of CNTs; where the CNTs have an ordered structure as grown, the arrangement of CNTs with particles is an arrangement ordered like or equally to the ordered structure of the CTNs as grown, where a modification of the distribution or number of particles determines a modification of mechanical response of the foam structure.

Further aspects of the disclosure are shown in the specification, drawings and claims of the present application.

### BRIEF DESCRIPTION OF THE DRAWINGS

FIG. 1A shows an exemplary scanning electron microscope image of unmodified CNTs (scale bars are 400 nm).

FIG. 1B shows an exemplary scanning electron microscope image (scale bars are 400 nm) of CNT array modified with SnO₂, which has conglomerated in the array interstices.

FIGS. 1C and 1D show exemplary embodiments of two different MnO₂ loadings (scale bars are 400 nm), both of which predominantly coated the individual CNTs themselves rather than forming conglomerations in the interstices.

FIG. 2A shows an exemplary transmission electron microscope high resolution image of individual CNT walls and crystalline MnO₂ particles (scale bar is 5 nm).

FIG. 2B shows an exemplary transmission electron microscope image of a group of aligned CNTs modified with MnO₂ particles (scale bar is 100 nm).

FIG. 2C shows an exemplary transmission electron microscope image (a closer view) of a single CNT corresponding to the white box in FIG. 2B (scale bar is 20 nm).

FIG. 2D shows an exemplary transmission electron microscope high resolution image of a MnO₂ particle corresponding to the white box in FIG. 2C (scale bar is 5 nm).

FIGS. 3A-3B show an exemplary stress-strain relationship of modified CNT arrays relative to their unmodified counterparts, where the MnO₂ modified samples display a larger improvement than the SnO₂ modified samples in energy dissipation (area of the hysteresis) relative to their corresponding control.

FIG. 3C shows an exemplary stress-strain relationship of modified CNT arrays relative to their unmodified counterparts, where by a fourth compressive cycle, both of the samples in FIG. 3A dissipate less energy than in earlier cycles, but the sample reinforced by MnO₂ still has a larger hysteresis than the unmodified sample.

FIG. 4A shows an exemplary mechanical performance of modified CNT arrays relative to their unmodified counterparts for repeated loading, where both MnO₂ and SnO₂ modified samples dissipate more energy during compression than control samples. However, the performance improvement for samples with SnO₂ is almost entirely gone by a fourth compressive cycle.

FIG. 4B shows an exemplary mechanical performance of modified CNT arrays relative to their unmodified counterparts for repeated loading; where though samples with MnO₂ dissipate more energy than both SnO₂ and control samples, they do not recover strain as well after compression.

FIG. 5A shows an exemplary top down scanning electron microscope image for the assessment of material failure after several compressive cycles to 0.8 strain (scale bars are 1 mm), where the CNT array modified with SnO₂ exhibits many lateral cracks.

FIG. 5B shows an exemplary top down scanning electron microscope image for the assessment of material failure after several compressive cycles to 0.8 strain (scale bars are 1 mm), CNT array modified with MnO₂ displaying much less lateral cracking comparatively.

FIG. 6A shows an exemplary schematic image of CNT bundles, where SnO₂ forms in clumps between CNT bundles, leading to brittle fracture and lateral cracking during compression followed by CNT driven partial elastic recovery.

FIGS. 6B-6C show an exemplary SEM images of a SnO₂-modified CNT array after compression and recovery from both the side and top, respectively (scale bars are 250 μm).

FIG. 6D shows an exemplary schematic image of CNT bundles, where MnO₂ forms as smaller particles along each CNT, leading to entanglement after compression, and less subsequent strain recovery.

FIG. 6E shows an exemplary SEM side image of a MnO₂ modified CNT array near the base, where compressive deformation predominates (scale bar is 100 μm).

FIG. 6F shows an exemplary image from the same region as in FIG. 6Et at higher magnification (scale bar is 500 nm).

### DETAILED DESCRIPTION

Throughout the present disclosure, embodiments and variations are described for the purpose of illustrating uses and implementations of the inventive concept. The illustrative description should be understood as presenting examples of the inventive concept, rather than as limiting the scope of the concept as disclosed herein. The words and phrases used in the present disclosure should be understood and interpreted to have a meaning consistent with the understanding of those words and phrases by those skilled in the relevant art.

In the present disclosure, the expression “nominally-aligned arrays of carbon nanotubes” can be used to refer ordered structures or arrangements of nanotubes which can naturally align themselves and can be held together by Van der Waals forces and lateral entanglement of the CNTs, which are not perfectly parallel (hence “nominally-aligned”). In this context, the term “alignment” can refer to “bundles” or “groups” of CNTs, and not specifically on the alignment of the individual tubes in the arrangement.

In the present disclosure, the expression “synthesis”, which is, for example, included in the expression “synthesis process”, “synthesis parameters” or “method for synthesizing”, can refer to a process in which volatile or gas-phase precursors including a carbon source, can react on a substrate, leading to nanotube growth. In some embodiments of the present disclosure, the synthesis can be a process based on chemical vapor deposition (CVD). In such cases, CVD synthesis can be achieved by taking carbon species in the gas phase and using an energy source, such as plasma, a resistively heated coil or heat in general, such as, the heat of a heated furnace to impart energy to a gaseous carbon molecule. Gaseous carbon sources can comprise, for example, toluene, methane, carbon monoxide, and acetylene. In such cases, the energy source can be used to “crack” the carbon molecule into a reactive radical species. These radical reactive species can then be diffused down to the substrate, which can be heated and coated in a catalyst (for example, a first row transition metal such as Ni, Fe, or, Co), where it can bond. According to some example embodiments, the synthesis of nominally-aligned CNTs can comprise a floating catalyst thermal chemical vapor deposition (TCVD) system with a reaction zone (furnace), a precursor solution comprising a catalyst and a carbon source, and a carrier gas to move the solution into the reaction zone. The synthesis of the CNTs can take place on a thermally oxidized surface, for example, Si surface, placed inside the furnace prior to the reaction.

In accordance with the present disclosure, mechanical properties of carbon nanotubes (CNTs) can be useful in many applications, [see, for example, reference 1, incorporated herein by reference in its entirety], which can serve as a motivation to design materials that can realize macroscale advantages through integrating these nanoscale structures [see, for example, reference 2, incorporated herein by reference in its entirety]. As known by a person skilled in the art that, among such design approaches, nominally aligned arrays (or “forests”) of millimeter-scale CNTs can be readily synthesized via standard chemical vapor deposition (CVD) techniques. Nominally aligned arrays (or “forests”) of millimeter-scale CNTs can exhibit behavior similar to fatigue-resistant, open-cellular foams under compression [see, for example, references 3 and 4, incorporated herein by reference in their entirety], with significant recovery from deformation and orders of magnitude superior energy dissipation relative to commercial foams of comparable density (0.1-0.3 g cm⁻³) [see, for example, reference 5, incorporated herein by reference in its entirety].

In some example embodiments, understanding the structure-property relationships for nominally aligned arrays of millimeter-scale CNTs materials, such as, how the bulk mechanical response can be affected by various structural features [see, for example, references 6-8, incorporated herein by reference in their entirety] can be beneficial. In order to study such properties, synthesis parameters can be altered to obtain CNT arrays with different features, allowing the study of how CNT surface roughness (see, for example, reference 6, incorporated herein as reference in its entirety), CNT diameter distribution (see, for example, reference 7, incorporated herein as reference in its entirety), or partially-graphitic layering around individual CNTs (see, for example, reference 8, incorporated herein as reference in their entirety.) can affect the bulk mechanical response. The control of these synthesis parameters combined with the modification of CNT arrays after synthesis (e.g., by the infiltration of polymer into array interstices [see, for example, reference 9, incorporated herein by reference in its entirety], or by the incorporation of surfactants and nanoparticles via solvent wetting [see for example, reference 10, incorporated herein by reference in its entirety]), can allow for tuning of the mechanical response, such as array stiffness and energy dissipation, under compression.

In some embodiments, nanoparticle modification of CNTs can be performed on disordered arrangements of CNTs that have first been dispersed in solution (often an acid) and then filtered. Such procedures can be performed to synthesize particles on disordered arrangements of CNTs such as ZnO [see, for example, reference 12, incorporated herein by reference in its entirety], Au [see, for example, reference 13, incorporated herein by reference in its entirety], Ni [see, for example, reference 14, incorporated herein by reference in its entirety], CaCO₃ [see, for example, reference 15, incorporated herein by reference in its entirety], Cu [see, for example, reference 16, incorporated herein by reference in its entirety], and others [see, for example, reference 17, incorporated herein by reference in its entirety]. SnO₂ nanoparticles can be integrated with disordered arrangements of CNTs using CVD [see, for example, reference 18, incorporated herein by reference in its entirety] and solution-based techniques [see, for example, reference 19, incorporated herein by reference in its entirety]. Moreover, in some embodiments, MnO₂ particles can be integrated with disordered CNTs [see for example, references 20, 21, incorporated herein by reference in their entirety] as well.

As known in the art, such materials can be used for various electrochemical applications, such as aqueous super-capacitors [see, for example, reference 22, incorporated herein by reference in its entirety]. The materials based on disordered agglomerates of surface-modified CNTs can be useful for some applications, without infiltration of particles deep inside CNT arrays. However, this can necessitate the loss of the ordered structure of CNT arrays. In some applications, such a CNT powder can be integrated into another, usually polymeric, matrix. This process can have difficulties of its own, such as the difficulty in obtaining uniform dispersion of the CNTs in the matrix [see, for example, reference 23, incorporated herein by reference in its entirety].

In some embodiments of the present disclosure, inorganic materials can be infiltrated into ordered CNT arrays. In such cases, a sol-gel process can be used to create a CNT-glass composite, however such cases can focus on enhancing thermal and electrical conductivities of the arrays [see, for example, reference 24, incorporated herein by reference in its entirety]. In some embodiments, low pressure CVD can be used as well, for short CNT arrays (for example, approximately 50 μm) due to difficulties in getting reactions to take place more than a few tens of microns deep in the array [see, for example, reference 25, incorporated herein by reference in its entirety]. Moreover, a vapor-assisted technique can be used to synthesize TiO₂ uniformly in short CNT arrays [see, for example, reference 26, incorporated herein by reference in its entirety]. However, in to some embodiments, the presence of nanoparticles (for example, metal particles or metal oxide particles) can improve the mechanical performance of CNT arrays without disrupting their ordered structure and can be useful to investigate the mechanical stability of the hybrid CNT-nanoparticle structures, which could be useful in multifunctional applications. Some example of such applications can be found in reference 31, incorporated herein by reference in its entirety. For example, SnO₂ and MnO₂, or other particles or substances, can be synthesized in CNT arrays without disrupting the ordered structure of the individual CNTs or the overall structure of the arrays themselves. Moreover, under compression the structures can exhibit a hysteretic response, similar to CNT arrays. Such structures modified with nanoparticles can dissipate up to twice the amount of energy as unmodified samples. Modifying CNT arrays with SnO₂ can result in brittle deposits of the oxide in the array interstices separated by elastic bundles of CNTs.

In accordance with the present disclosure, in some embodiments, compressing CNT arrays that have been modified with SnO₂ can result in lateral fracturing through the oxide deposits, followed by elastic recovery of the CNT bundles. In such cases, after a few compressive cycles, the material with SnO₂ responds similarly to unmodified CNT arrays in compression (as compared by quasistatic stress-strain data and energy dissipation). In contrast, when MnO₂ particles are synthesized in CNT arrays by emersion of the CNTs in aqueous KMnO₄, the particles can form on the individual CNTs themselves. The modifications can result in higher energy dissipation during compression and minimal lateral fracturing after repeated cycling, but can yield more entanglement of the individual CNTs, resulting in less strain recovery after compression.

As known by a person skilled in the art, electrochemical applications have been developed for similar materials and continued study of the mechanical properties of these systems can lead to useful multifunctional materials with simultaneous mechanical and electrochemical uses. Moreover, dispersion of particles deep within millimeter-scale arrays can be obtained without altering the crystalline structure of the individual CNTs or the ordered arrangement of them. In addition to modifying the CNT arrays, the ordered arrangement of CNTs can be tested under quasistatic compression to examine how energy dissipation, strain recovery, loading/unloading modulus, and permanent damage are affected by the modifications. Understanding of these mechanical properties can be a first step toward the use of materials based on nanoparticle-CNT array structures in relevant applications, such as electrochemical applications [see, for example, reference 27, incorporated herein by reference in its entirety].

In accordance with the present disclosure, the previously indicated methods can be a novel approach for modifying the mechanical response of CNT arrays post-synthesis. For example, the CNT arrays can be reinforced by coating the individual CNT surfaces or filling the interstices of the arrays with metal oxide particles, or other particles or substances that can be synthesized in situ in the CNT arrays. In other words, the CNT arrays can have particles or other substances added, which can be extraneous with respect to the CNT material, and can be synthesized in situ in the CNT arrays. These particles or other substance can be synthesized in the CNT material after synthesis of the CNT material.

According to some embodiments of the present disclosure, two different procedures can be used to synthesize MnO₂ and SnO₂ particles in the CNT arrays. For the synthesis of MnO₂ particles, a solution-based approach can be used. This approach is described in more detail in subsequent paragraphs of the present disclosure. For the synthesis of SnO₂ particles, a kinetically-controlled catalytic synthesis approach can be used, similar to that used for growing Sn particles in situ in graphitic anodes for electrochemical applications [see, for example, reference 11, incorporated herein by reference in its entirety]. In both cases, the particles can be synthesized in situ in the CNT arrays.

According to several example embodiments of the present disclosure, in relation to CNTs and synthesis of CNTs, arrays of multiwall carbon nanotubes (CNTs) can be synthesized using a thermal chemical vapor deposition (CVD) system and a floating catalyst approach described in references 7 and 28, each of which is incorporated herein by reference in its entirety]. In such cases, the growth substrate can be thermally oxidized Si placed in a CVD furnace set to 827° C. A 0.02 g ml-solution of ferrocene (i.e., a precursor of Fe, a catalyst for CNT synthesis) and toluene (i.e., a carbon source for CNT synthesis) can be injected at a rate of 1 ml min⁻¹ using a syringe pump into the heating zone, with Ar as a carrier gas. This approach can result in continued deposition of new catalyst, and thereby continued initiation of new CNT growth, throughout the synthesis process. CNT array samples (for example, with heights of 1-1.5 mm, a cross sections of 10-20 mm², volume occupied by CNTs ˜10%, and individual CNT diameters of 40-50 nm, as characterized by transmission electron microscopy in reference 7, incorporated herein as reference in its entirety) can be removed from their growth substrates using a razor blade. In such cases, the mass for each of these samples can be measured using a microbalance, which can be used to calculate the bulk density, both before and after synthesis of the oxide particles.

In some embodiments, loading of SnO₂ particles can follow steps similar to those discussed in reference 11, incorporated herein as reference in its entirety. In such cases, CNT samples can be first added to aqueous SnCl₂ (for example, 0.2 M, 5 ml) with, for example, 0.6 ml of acetone added to aid absorption into the array. After soaking for, for example, 46 h at room temperature, the CNT samples can be fully wetted with the SnCl₂ solution and placed in a sealed container with an open solution of ammonia (for example, 2% wt.). Consequently, the ammonia vapor can gradually diffuse to the sample, initiating hydrolysis of the SnCl₂ solution contained inside the CNT array. The samples can then be removed and washed with deionized water, followed by further heat treatment in, for example, N₂ at 450° C. for 1 h at the heating rate of 5° C. min⁻¹, yielding the final CNT/SnO₂. To load MnO₂ particles into the CNT arrays, the CNT samples can be soaked in, for example, aqueous KMnO₄ (0.2 M, 5 ml) for 46-120 h (with the variation in time controlling the loading amount) at room temperature. During the soaking, MnO₂⁻ can be spontaneously reduced to MnO₂ on the surface of the CNTs, which can act as a reducing agent [see, for example, reference 21, incorporated herein as reference in its entirety]. After soaking, the sample can be subjected to further heat treatment in N₂ at 450° C. for 1 h at a heating rate of 5° C. min⁻¹, yielding the final CNT/MnO₂. Scanning electron microscopy (SEM) can be used to obtain images of sample structure at different magnifications and locations for each sample. By counting the number of CNTs crossing an arbitrary horizontal line at different locations, it can be determined that there are no statistically significant changes in the spacing of individual CNTs.

According to some example embodiments of the present disclosure, two samples with SnO₂ and five samples with MnO₂ can be synthesized following the procedures as described above, and can be compared to the performance of three unmodified control samples. Samples can be repeatedly compressed quasistatically, using a commercial materials test system (for example, Instron E3000), to 0.8 strain (with strain being defined as the displacement normalized by sample height; i.e., 0.8 strain is equivalent to compressing the sample until it is only 20% of its original height). These compressions can occur at a strain rate of 0.03 s⁻¹ (i.e., 3% of the original sample height every second). In such cases, for each modified CNT array an unmodified “control” sample can be tested that has been removed from the growth substrate directly adjacent to it, and therefore can have almost the exact same height, density, mean CNT diameter, etc., prior to modification.

In such cases, as mentioned in the previous paragraph, energy dissipation per unit volume can be obtained by integrating the area of the stress-strain hysteresis for each loading cycle. The loading modulus can then be calculated by examining the initial slope of the stress-strain curve. Similarly, the unloading modulus can be calculated by taking the slope of the stress-strain curve after unloading from maximum strain has just begun (corresponding to a drop in stress to ⅔ of the maximum stress). Thermo-gravimetric analysis (for example, TGA, Mettler-Toledo 851e instrument) can be conducted at 550° C. in air to quantify the amount (wt. %) of particle loading for each modified sample. Consequently, the type of oxide can be determined after synthesis of the particles using x-ray diffraction (XRD), Philips microscopy using a FEI Quanta 200F, and transmission electron microscopy using a FEI TF30UT at 300 kV.

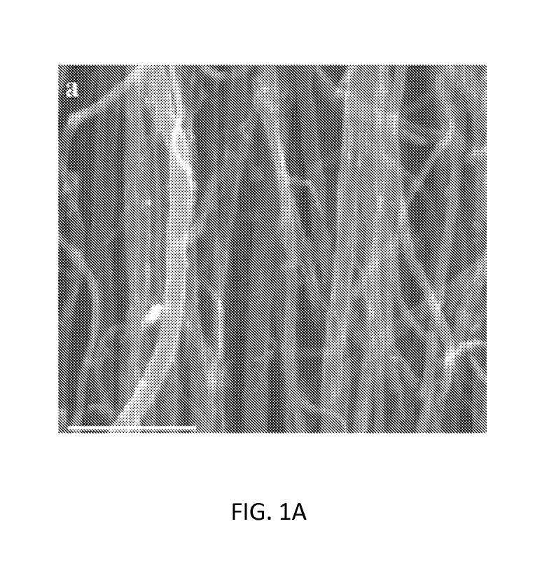

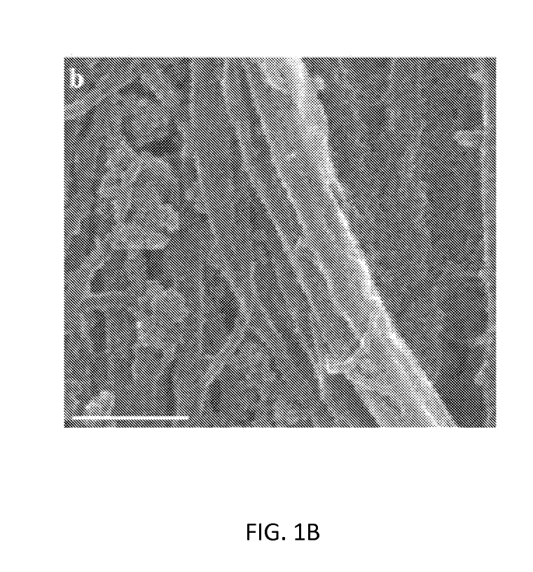

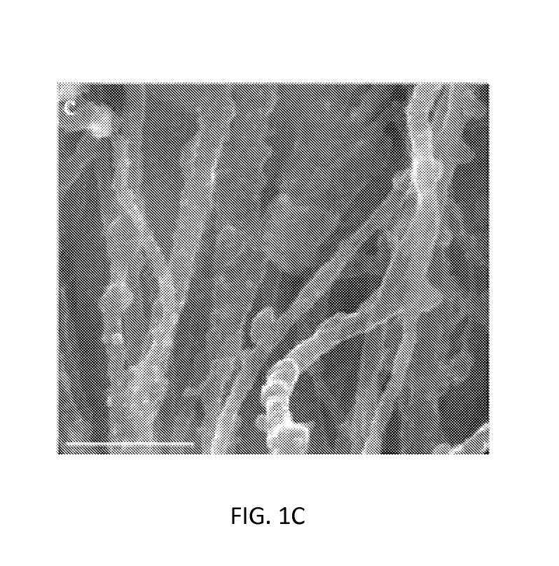

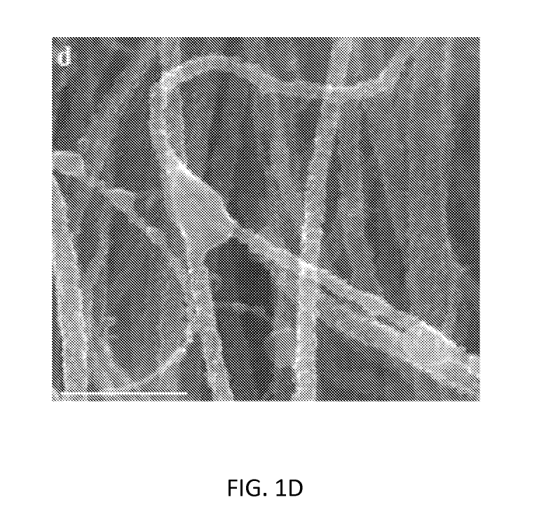

In some embodiments, after synthesizing oxide nanoparticles in the CNT arrays with various loadings (i.e., different quantities of SnO₂ or MnO₂ as quantified by wt. %) following relevant experimental procedures, samples can be characterized with scanning electron microscopy (SEM) and transmission electron microscopy (TEM). For example, in accordance with the present disclosure, the example embodiments of FIGS. 1A-1D compare SEM images of an unmodified array (FIG. 1A) with one modified with SnO₂ (FIG. 1B) and two instances of arrays modified with MnO₂ (FIGS. 1C and 1D). These images illustrate that the way in which the nanoparticles modify the CNT arrays can depend on particle type (i.e., SnO₂ versus MnO₂). In FIGS. 1A-1D, the images can represent the appearance at this scale at every location internal to the arrays at which it was investigated (i.e., there is no apparent formation of separate densified or cell regions, as determined by SEM images at many different locations and magnifications).

As shown in the example embodiment of FIG. 1B, the SnO₂ particles can form conglomerations in the array interstices, forming pockets of oxide rather than coating the individual CNTs. In contrary, as shown in FIGS. 1C and 1D, the MnO₂ particles can form uniformly along the individual CNTs. This is in agreement with the qualitative observations that MnO₂ forms a more uniform, tightly-bound coating around CNTs than SnO₂ [see, for example, reference 22, incorporated herein as reference in its entirety]. In such cases, different affinities can be a result of the different roles that the CNTs play in the two different reactions.

As described in the previous paragraphs, the synthesis of SnO₂ can be performed from aqueous SnCl₂ precursor contained in the CNT array, using a hydrolyzing agent (ammonia) to cause the precipitation of Sn(OH)Cl that is converted to SnO₂ in the subsequent heat treatment. In such cases, the CNT array can provide a substrate/space to accommodate the SnO₂ but may not play an active role in the reaction. For the synthesis of MnO₂, with aqueous KMnO₄ as precursor, the CNTs can take a more active role in the reaction, acting as both a reducing agent and a substrate for MnO₂ precipitation [see, for example, references 20 and 21, incorporated herein as reference in their entirety]. This can result in particles being formed mainly on CNTs, not everywhere in the interstices. In the example embodiments of FIGS. 1C and 1D, two different examples are given for MnO₂ in which the particle synthesis parameters used were nearly the same yet slightly different morphological features developed. The sample in FIG. 1C has a lower total amount of MnO₂ loaded relative to the sample in FIG. 1D due to a shorter soak time in the KMnO₄ precursor solution, despite having significantly larger particles. As known in the art, the morphology of nanoparticles resulting from the MnO₂ synthesis can be sensitive to local pH and temperature [see, for example, reference 21, incorporated herein as reference in its entirety]. Minor variations in these parameters could therefore explain the observed morphological differences. As small as these morphological differences are, they may affect mechanical properties, as discussed in the subsequent paragraphs.

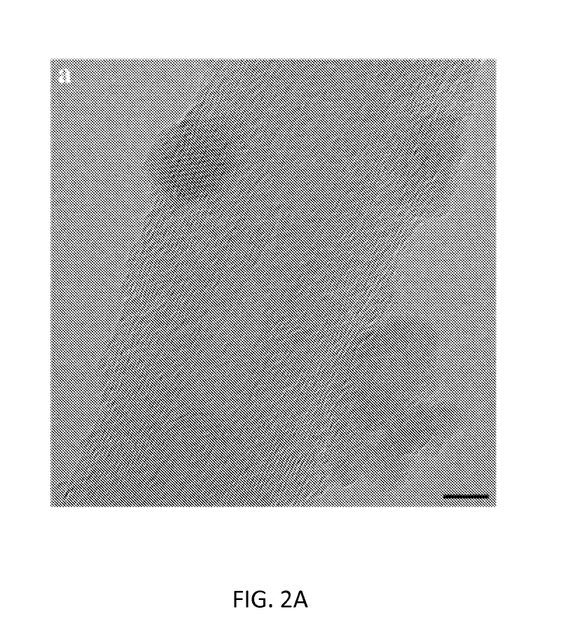

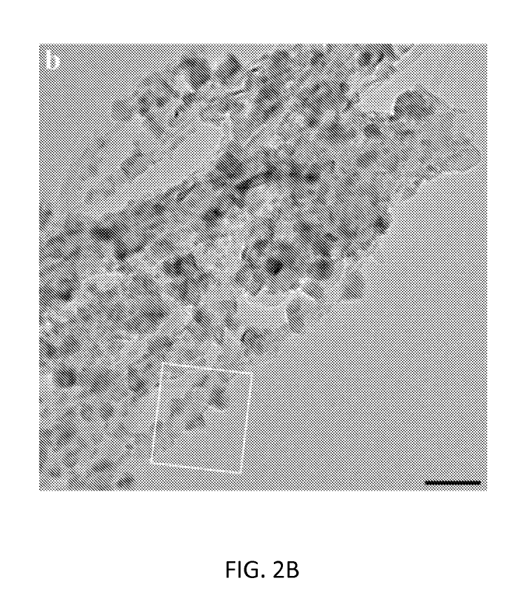

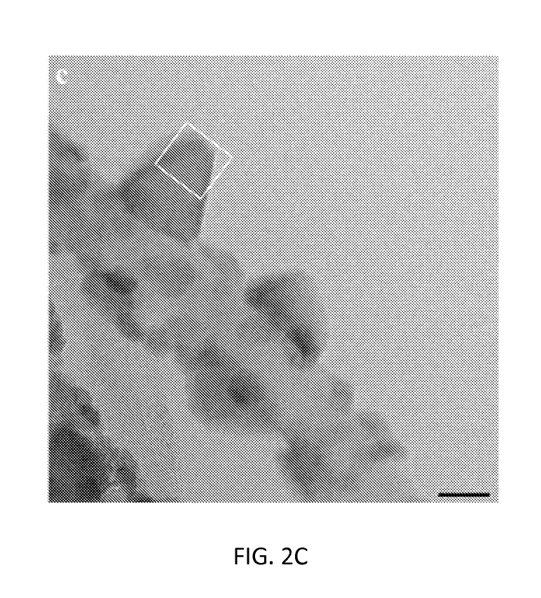

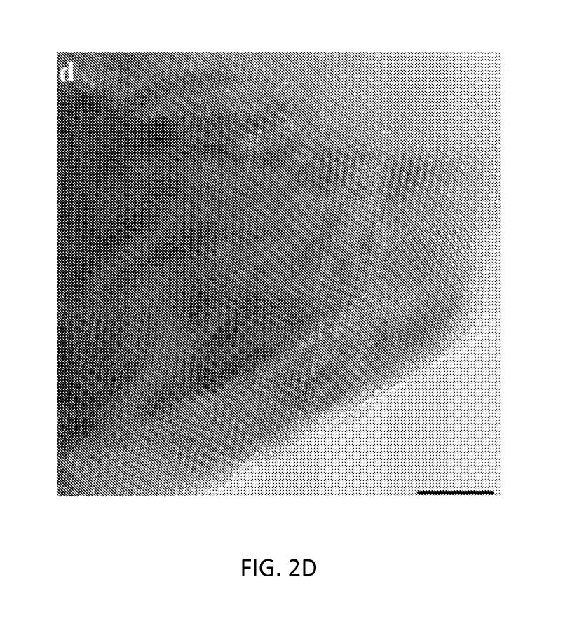

In accordance with the present disclosure, example embodiments of FIGS. 2A-2D show TEM images for CNT samples modified with MnO₂. The exemplary high resolution image of FIG. 2A shows the individual walls of the CNTs and the crystalline nature of the attached MnO₂ particles. As shown in the exemplary images of FIG. 2B, approximately a dozen roughly aligned CNTs with many MnO₂ particles are entangled together (FIG. 2B), displaying a similar morphology to that shown in earlier SEM images (FIG. 1C). The exemplary higher magnification images of FIGS. 2C and 2D show the interface between a CNT and particles (FIG. 2C) and a high resolution view of one of these particles (FIG. 2D). The strong interaction between MnO₂ particles and CNTs observed in these exemplary images is not seen in the case of SnO₂ particles. However, despite the affinity of the MnO₂ particles for the CNTs, these exemplary images do not reveal any damage to the CNT walls or partial embedding of the particles into the walls.

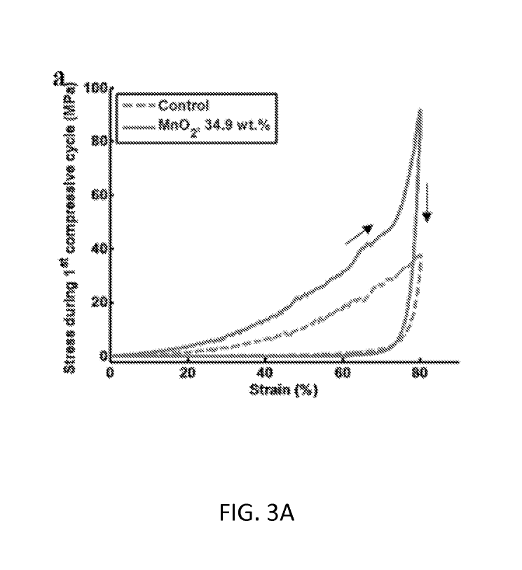

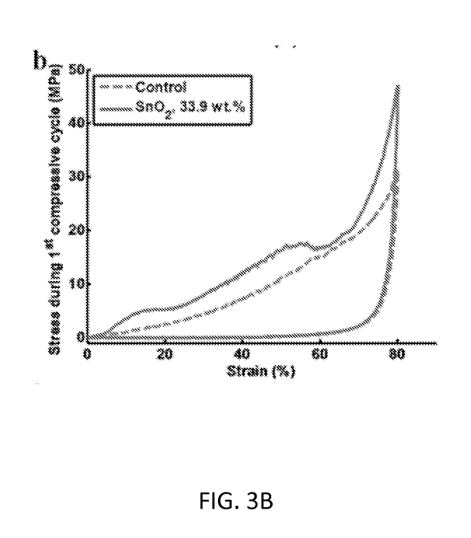

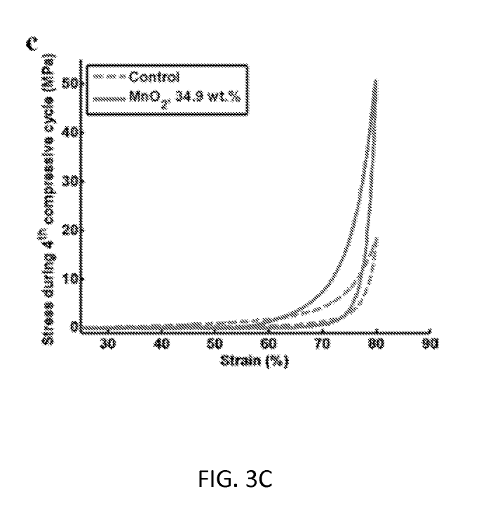

In accordance with the present disclosure, representative compressive stress-strain responses for samples modified with MnO₂ and SnO₂ are shown in exemplary embodiments of FIGS. 3A and 3B, respectively, with the response of corresponding control samples indicated by the dashed lines. In exemplary FIGS. 3A and 3B, a hysteretic response can be observed in all cases, as is typical for CNT arrays under compression to large strains [see for example, reference 4, incorporated herein as reference in its entirety], with separate loading and unloading paths (i.e., following the path indicated by the arrows in FIG. 3A). Similar stress-strain curves can be gathered for numerous samples, and can be used to calculate loading modulus (i.e., slope of the initial linear region corresponding to small strains), unloading modulus (i.e., the slope of the curve at high strain, right after the peak value has been reached and unloading has begun), and energy dissipation. These quantities are summarized in table 1, which is shown in subsequent paragraphs of this disclosure. The area of the stress-strain hysteresis can represent the energy dissipated per unit volume. The exemplary graphs of FIGS. 3A and 3B show the improvement in energy dissipation for the sample modified with MnO₂ relative to its control (see, FIG. 3A, approximately 100% improvement in this case), as compared to the sample modified with SnO₂ relative to its control (FIG. 3B, about 42% improvement in this case). In both cases, superior energy dissipation can be observed for samples loaded with MnO₂ relative to those loaded with SnO₂.

In some embodiments, in addition to these differences resulting from the different particle types, an effect from particle morphology can exist within a given category of particle type. As mentioned earlier, the morphological differences between the samples displayed in the exemplary images of FIGS. 1C and 1D (both modified with MnO₂) could contribute to the differences in energy dissipation between the two cases, with the former (FIG. 1C) dissipating approximately 70% more energy than the latter (FIG. 1D) during equivalent compression tests. Moreover, the latter sample (FIG. 1D), with less energy dissipation, was actually loaded with a higher quantity of MnO₂ (for example, 40.2 wt. % rather than 34.9 wt. %).

In some embodiments, further examination can be performed on the response of the samples under repeated compressive loading. As known by a person skilled in the art, one of the properties of as-grown CNT arrays synthesized by floating catalyst CVD is their ability to dissipate energy and to recover much of their original height even after many compressive cycles to high strain (0.8 or higher) [see, for example, references 3 and 4, incorporated herein as reference in their entirety]. In such cases, the first cycle can reach the highest peak stress and can dissipate the largest quantity of energy, with a significant drop in these for the second cycle. After only a few compressive cycles, however, the material can begin to reach a steady state response that does not vary significantly from cycle to cycle [see, for example, reference 7, incorporated herein as reference in its entirety]. In some cases, it can be observed that the response to repeated loading can depend on whether the sample was reinforced with MnO₂ or instead with SnO₂. As shown in the exemplary graph of FIG. 3C, samples modified with MnO₂ can have higher peak stress and larger hysteresis area (i.e., energy dissipation) than their respective control samples even for repeated compressive cycles. The similar characteristics cannot be observed for samples modified with SnO₂, which by the fourth cycle can show a nearly identical mechanical response to their respective control samples.

In table 1 as shown below, loading and unloading modulus and energy dissipation per unit volume of modified and unmodified samples are provided.

TABLE 1

| | Loading | Loading | Unloading | Unloading | En. | En. |
|---|---|---|---|---|---|---|
| | mod., cyc 1 | mod., | mod., | mod., | dissipation, | dissipation, |
| | (MPa) | cyc 4 (MPa) | cyc 1 (MPa) | cyc 4 (MPa) | cyc1 (MJm⁻³) | cyc4 (MJ m⁻³) |
| Control | 6.6 ± 3.8 | 3.1 ± 1.8 | 1710 ± 330 | 900 ± 290 | 6.89 ± 0.49 | 0.71 ± 0.18 |
| SnO₂ | 41 ± 8 | 2.4 ± 0.6 | 2860 ± 230 | 1090 ± 150 | 9.71 ± 0.58 | 0.60 ± 0.05 |
| MnO₂ | 9.3 ± 5.6 | 23 ± 6 | 4170 ± 400 | 3180 ± 190 | 13.0 ± 1.6 | 1.40 ± 0.24 |

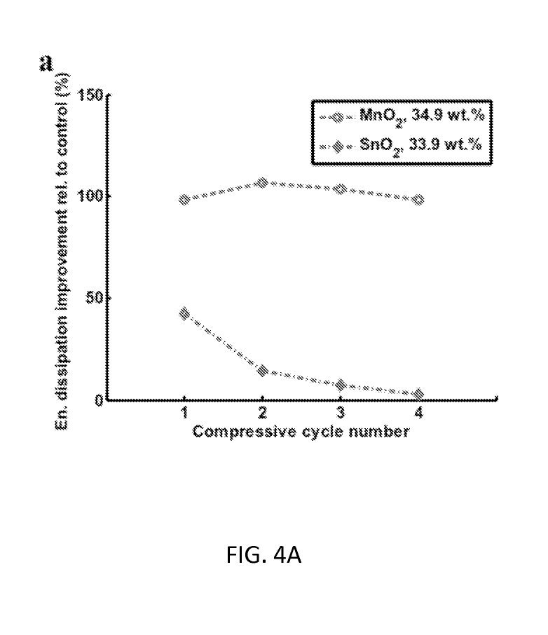

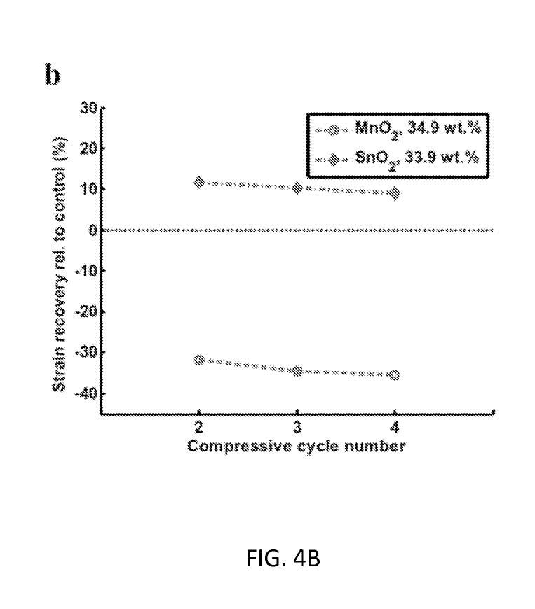

According to example embodiments of the present disclosure, FIGS. 4A and 4B illustrate in more detail the difference between the response of samples modified with MnO₂ under repeated loading and that of the samples modified with SnO₂. Since the unmodified control samples show decreased performance with repeated loading, FIGS. 4A and 4B show the responses of modified samples relative to the response of the control samples (i.e., in this case the first compressive cycle for the modified samples are compared to the first cycle of the unmodified samples, the second compressive cycle for the modified samples to the second cycle of the unmodified samples, etc). The exemplary graph of FIG. 4A shows relative energy dissipation for the first four compressive cycles. As previously indicated, the sample modified with MnO₂ can dissipate approximately 100% more energy than its control during the first compressive cycle. It continued to dissipate approximately 100% more energy than the control sample in subsequent cycles as well.

In the case of samples modified with SnO₂, however, by the fourth compressive cycle, the material can behave almost identically to the control, dissipating approximately the same amount of energy and attaining approximately the same peak stress, as shown in the exemplary graph of FIG. 4A). As known in the art that, in terms of energy dissipation for repeated loading, the properties of CNT arrays modified with MnO₂ particles can be advantageous compared to those modified with SnO₂, which in some embodiments, is not advantageous over their control within a few compressive cycles. However, when strain recovery is considered the samples can respond in the opposite manner. The exemplary graph of FIG. 4B shows the initial heights of the modified samples relative to those of their respective control samples at the beginning of each compressive cycle. This result can indicate the amount of strain that the CNT array recovers after the previous compressive cycle. With the control samples indicated by the horizontal line at 0% (by definition), it can be observed that samples modified with MnO₂ recovered significantly less strain after compression than did either the control samples or those modified with SnO₂. As seen in FIG. 4B, the latter recovered slightly more strain after compression than the control samples, which can be related to disruption of some of the lateral entanglement between CNT bundles.

In some embodiments, examining the loading and unloading moduli can be useful to understand the compressive response under repeated loading cycles. As summarized in the exemplary table 1, the initial loading moduli for exemplary samples modified with SnO₂ have an average value (41±8 MPa) approximately an order of magnitude higher than those of either the unmodified samples or those modified with MnO₂. However, by the fourth cycle (see table 1) the average loading modulus for exemplary samples with SnO₂ has dropped by an order of magnitude to closely match the average value for unmodified samples. In contrast, the exemplary samples with MnO₂ show a substantial increase in loading modulus after a few cycles. In the exemplary table 1, all samples show a decrease in unloading modulus after the first cycle, though the samples with MnO₂ show a decrease of a relatively smaller value.

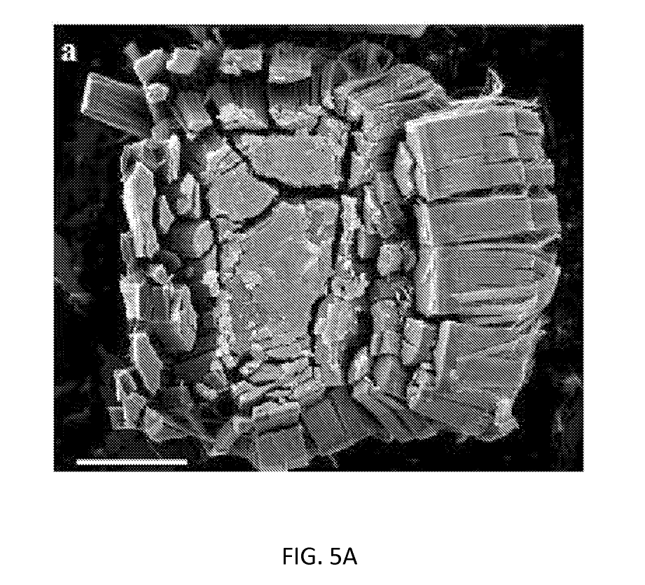

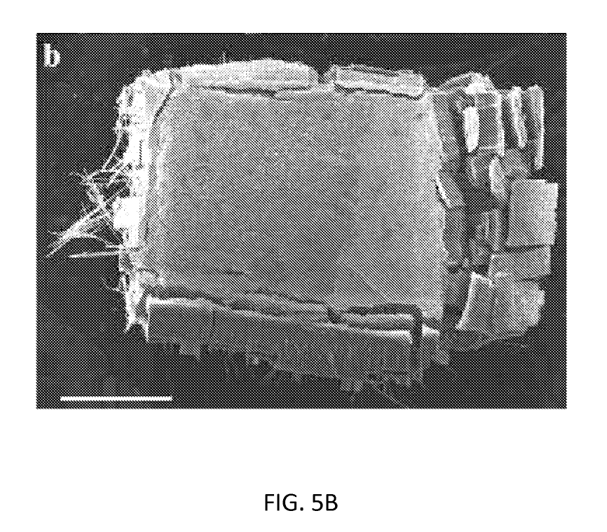

In accordance with the present disclosure, the results discussed above and displayed in FIGS. 4A-4D can be explained by returning to the SEM images in FIGS. 1A-1D to understand the different morphologies that can result from modifying the CNTs by either SnO₂ or MnO₂. As previously indicated, the SnO₂ particles can form interstitial conglomerations without substantially modifying the individual CNTs (see FIG. 1B) whereas the MnO₂ particles can form directly on the individual CNT surfaces (see, FIGS. 1C and 1D). As shown in the example embodiment of FIG. 5, in some embodiments, it can be useful to combine these observations with top down SEM images taken of the samples after they were repeatedly compressed, which can indicate how the materials tend to fail. In such cases, the samples modified with SnO₂ can display many lateral cracks that form perpendicular to the long CNT axes, as shown in FIG. 5A.

Moreover, in some embodiments, such behavior can be in accordance with the morphology displayed in FIG. 1B, in which brittle pockets of oxide between elastic CNT bundles can serve as natural locations of fracture. This can explain the high loading modulus obtained in the first cycle, with a large contribution from the oxide deposits, followed by very low values of loading modulus for later cycles, since the oxide deposits could be failed in brittle fashion (see table 1). With these parallel brittle and elastic elements in compression the material can fracture into small elastic bundles of CNTs. As shown in FIG. 4a, after the first couple of cycles these elastic bundles no longer interact as strongly with one another, causing the loss of the initial improvement in energy dissipation with repeated loading. Consequently, once the oxide is fractured and no longer coupling adjacent CNT bundles, the recovery of the material after compression can be driven by the elastic CNTs, which can be highly resilient against bending and buckling [see for example references 29 and 30, incorporated herein by reference in their entirety], not inhibited by the fractured oxide deposits. This can result in the large strain recovery for samples modified by SnO₂ shown in FIG. 4B.

In contrast, as shown in the example embodiment of FIG. 5B, the samples modified with MnO₂ show insignificant lateral cracking, in accordance with a morphology predominantly consisting of individually modified CNT surfaces (see FIGS. 1C and 1D) rather than large deposits of oxides between separated CNT bundles. With this morphology, the mechanical response can be driven by interactions between individual CNTs rather than the material breaking into separated CNT bundles. As shown in the exemplary graphs of FIGS. 4A and 4B, the result can indicate a consistently improved energy dissipation even after repeated compressive loading (FIG. 4A), but poor strain recovery due to entanglement among the individual CNTs in the compressed state (FIG. 4B). This is also in agreement with the increase in loading modulus for the samples modified with MnO₂ (table 1). Since, in some embodiments, samples modified with MnO₂ cannot recover well from compression, they remain in a densified state. This increased density for later compressive cycles can correspond to an increased loading modulus.

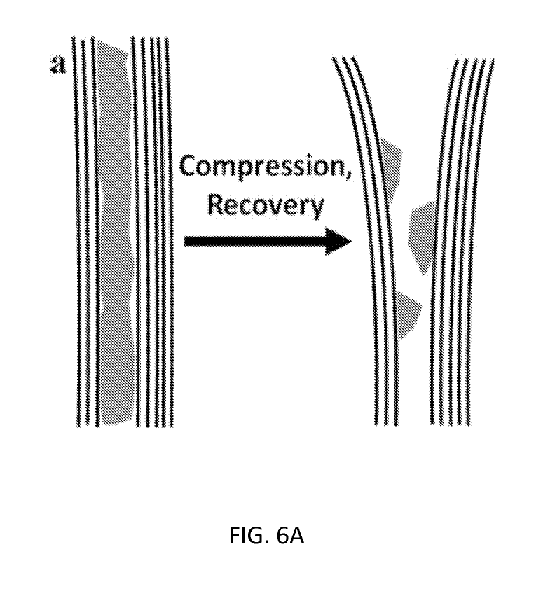

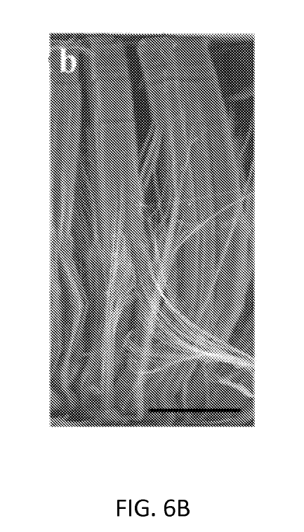

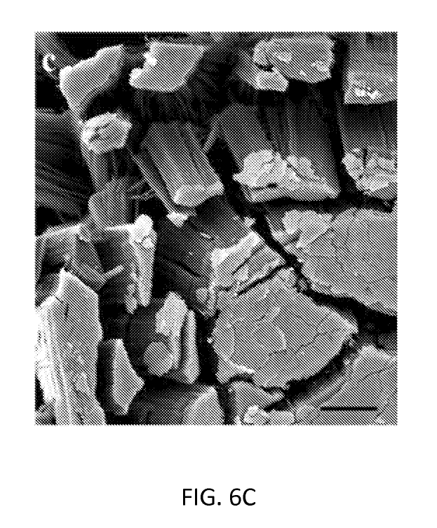

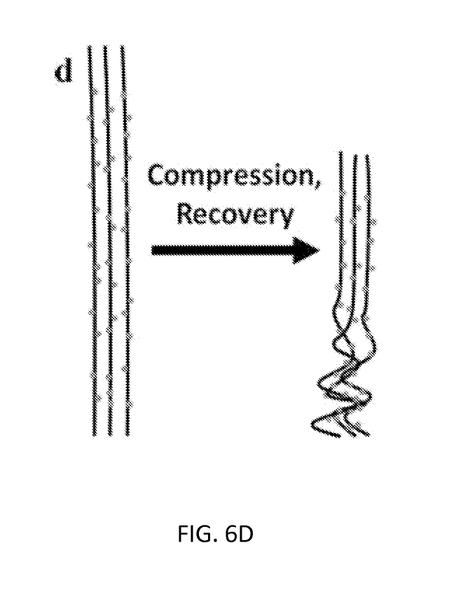

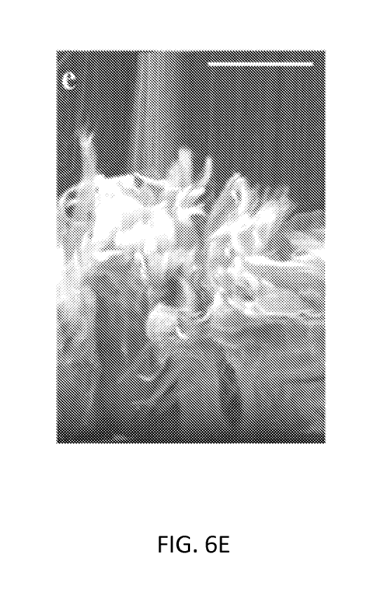

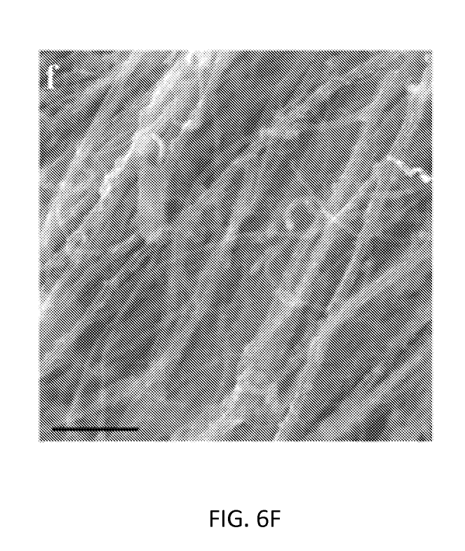

In accordance with the present disclosure, FIGS. 6A-6F illustrate diagrams and additional SEM images. The example embodiments of FIG. 6A represents a sample modified with SnO₂ that is compressed, requiring the brittle fracture of oxide between CNT bundles, followed by recovery driven by the now uninhibited elastic CNT bundles. The example embodiments of FIGS. 6B and 6C provide a view from the side and top of the CNT array, respectively, using SEM. The side view shows recovery of the CNT bundles, and the top view shows separation of the bundles. In contrast, the samples modified with MnO₂ (FIGS. 6D-6F) show little cracking but recover much less of their original height after compression. The example embodiments of FIGS. 6E and 6F show permanent entanglement of individual CNTs at two different magnifications. This discussion can explain the existence of plateaus in the stress-strain curves for samples modified with SnO₂ (e.g., FIG. 3B) which cannot be observed for the samples modified with MnO₂ (e.g., FIG. 3A). In some embodiments, such plateaus are only observed for the first compressive cycle, and therefore can correspond to brittle failure during the formation of lateral cracks through the oxide deposits. It is clear from FIG. 5B that even the samples modified by MnO₂ display some lateral cracking along the edges of the samples after compressive loading. This can occur to some extent even in unmodified CNT arrays due to a lack of inward lateral support at the edges.

In addition to Sn and Mn oxides, Fe oxide and Co oxide particles can be synthesized as well, using corresponding metal salts as precursors and following similar procedures as described earlier. Subjecting the oxide particles to carbothermal reduction can form metallic particles. Moreover, as known by a person skilled in the art that, the versatility of the processes described in the present disclosure as a proof of concept, further work is necessary, including the synthesis of a larger number of such samples, to understand the systematic effects of these different types of particle loadings on the mechanical properties. The integrity of these structures under mechanical stresses can be understood by understanding how the affinities of the various types of particles for CNTs can differ from one another, as discussed in the present disclosure for SnO₂ and MnO₂.

The examples set forth above are provided to give those of ordinary skill in the art a complete disclosure and description of how to make and use the embodiments of the disclosure, and are not intended to limit the scope of what the inventors regard as their disclosure. Modifications of the above-described modes for carrying out the disclosure may be used by persons of skill in the art, and are intended to be within the scope of the following claims. All patents and publications mentioned in the specification may be indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only, and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

A number of embodiments of the disclosure have been described. Nevertheless, it will be understood that various modifications may be made without departing from the spirit and scope of the present disclosure. Accordingly, other embodiments are within the scope of the following claims.

### LIST OF CITED REFERENCES

[1] Qian D, Wagner G J, Liu W K, Yu M, Ruoff R S. Mechanics of Carbon Nanotubes. Appl. Mech. Rev. 2002; 55(6):495-532.
[2] Liu L, Ma W, Zhang Z. Macroscopic Carbon Nanotube Assemblies: Preparation, Properties, and Potential Applications. Small 2011; 7(11):1504-20.
[3] Suhr J, Victor P, Ci L, Sreekala S, Zhang X, Nalamasu O, et al. Fatigue Resistance of Aligned Carbon Nanotube Arrays Under Cyclic Compression. Nat. Nanotech. 2007; 2(7):417-21.
[4] Cao A Y, Dickrell P L, Sawyer W G, Ghasemi-Nejhad M N, Ajayan P M. Super-Compressible Foamlike Carbon Nanotube Films. Science 2005; 310(5752):1307-10.
[5] Misra A, Raney J R, De Nardo L, Craig A E, Daraio C. Synthesis and Characterization of Carbon Nanotube Multilayer Structures. ACS Nano 2011; 5(10):7713-21.
[6] Bradford P D, Wang X, Zhao H, Zhu Y T. Tuning the Compressive Mechanical Properties of Carbon Nanotube Foam. Carbon 2011; 49(8):2834-41.
[7] Raney J R, Misra A, Daraio C. Tailoring the Microstructure and Mechanical Properties of Arrays of Aligned Multiwall Carbon Nanotubes by Utilizing Different Hydrogen Concentrations During Synthesis. Carbon 2011; 49(11):3631-8.
[8] Li X, Ci L, Kar S, Soldano C, Kilpatrick S J, Ajayan P M. Densified Aligned Carbon Nanotube Films via Vapor Phase Infiltration of Carbon. Carbon 2007; 45(4):847-51.
[9] Ci L, Suhr J, Pushparaj V, Zhang X, Ajayan P M. Continuous Carbon Nanotube Reinforced Composites. Nano Lett. 2008; 8(9):2762-6.
[10] Misra A, Raney J R, Craig A E, Daraio C. Effect of Density Variation and Non-Covalent Functionalization on the Compressive Behavior of Aligned Carbon Nanotubes. Nanotechnol. 2011; 22:425705.
[11] Zhang H L, Morse D E. Kinetically Controlled Catalytic Synthesis of Highly Dispersed Metal-in-Carbon Composite and its Electrochemical Behavior. J. Mater. Chem. 2009; 19(47):9006-11.
[12] Guo G, Guo J, Tao D, Choy W C H, Zhao L, Qian W, et al. A Simple Method to Prepare Multi-Walled Carbon Nanotube/ZnO Nanoparticle Composites. Appl. Phys. A. 2007; 89(2):525-8.
[13] Moon S Y, Kusunose T, Tanaka S, Sekino T. Easy Synthesis of a Nanostructured Hybrid Array Consisting of Gold Nanoparticles and Carbon Nanotubes. Carbon 2009, 47(12):2924-32.
[14] Bittencourt C, Felten A, Ghijsen J, Pireaux J J, Drube W, Erni R, et al. Decorating Carbon Nanotubes with Nickel Nanoparticles. Chem. Phys. Lett. 2007; 436(4-6):368-72.
[15] Liu Y, Wang R, Chen W, Chen X, Hu Z, Cheng X, et al. Kabob-Like Carbon Nanotube Hybrids. Chem. Lett. 2006; 35(2):200-1.
[16] Zhao B, Yadian B L, Li Z J, Liu P, Zhang Y F. Improvement on Wettability Between Carbon Nanotubes and Sn. Surface Engineering 2009; 25(1):31-5.
[17] Eder D. Carbon Nanotube-Inorganic Hybrids. Chem. Rev. 2010; 110(3):1348-85.
[18] Kuang Q, Li S F, Xie Z X, Lin S C, Zhang X H, Xie S Y, et al. Controllable Fabrication of SnO₂—Coated Multiwalled Carbon Nanotubes by Chemical Vapor Deposition. Carbon 2006; 44(7):1166-72.
[19] Han W Q, Zettl A. Coating Single-Walled Carbon Nanotubes with Tin Oxide. Nano Lett. 2003; 3(5):681-3.
[20] Jin X, Zhou W, Zhang S, Chen G Z. Nanoscale Microelectrochemical Cells on Carbon Nanotubes. Small 2007; 3(9):1513-7.
[21] Ma S B, Ahn K Y, Lee E S, Oh K H, Kim K B. Synthesis and Characterization of Manganese Dioxide Spontaneously Coated on Carbon Nanotubes. Carbon 2007; 45(2):375-82.
[22] Ng K C, Zhang S, Peng C, Chen G Z. Individual and Bipolarly Stacked Asymmetrical Aqueous Supercapacitors of CNTs/SnO2 and CNTs/MnO2 Nanocomposites. J. Electrochem. Soc. 2009; 11:A846-53.
[23] Xie X L, Mai Y W, Zhou X P. Dispersion and Alignment of Carbon Nanotubes in Polymer Matrix: A Review. Mater. Sci. Eng. R 2005; 49(4):89-112.
[24] Otieno G, Koos A A, Dillon F, Wallwork A, Grobert N, Todd R I. Processing and Properties of Aligned Multi-Walled Carbon Nanotube/Aluminoborosilicate Glass Composites Made by Sol-Gel Processing. Carbon 2010; 48(8):2212-7.
[25] Chandrashekar A, Ramachandran S, Pollack G, Lee J S, Lee G S, Overzet L. Forming Carbon Nanotube Composites by Directly Coating Forests with Inorganic Materials Using Low Pressure Chemical Vapor Deposition. Thin Solid Films 2008; 517(2):525-30.
[26] Neocleus S, Pattinson S W, Moisala Motta A M, Windle A H, Eder D. Hierarchical Carbon Nanotube-Inorganic Hybrid Structures Involving CNT Arrays and CNT Fibers. Func. Mater. Lett. 2011; 4(1):83-9.
[27] Wang W, Epur R, Kumta P N. Vertically Aligned Silicon/Carbon Nanotube (VASCNT) Arrays: Hierarchical Anodes for Lithium-Ion Battery. Electrochem. Comm. 2011; 13(5):429-32.
[28] Andrews R, Jacques D, Rao A M, Derbyshire F, Qian D, Fan X, et al. Continuous Production of Aligned Carbon Nanotubes: A Step Closer to Commercial Realization. Chem. Phys. Lett. 1999; 303(5-6):467-74.
[29] Falvo M R, Clary G J, Taylor R M, Chi V, Brooks F P, Washburn S, et al. Bending and Buckling of Carbon Nanotubes Under Large Strain. Nature 1997; 389(6651):582-4.
[30] Yakobson B I, Brabec C J, Bernholc J. Nanomechanics of Carbon Tubes: Instabilities beyond Linear Response. Phys. Rev. Lett. 1996; 76(14):2511-4.
[31] Jordan R. Raney, Hong-Li Zhang, Daniel E. Morse, Chiara Daraio, “In situ synthesis of metal oxides in carbon nanotube arrays and mechanical properties of the resulting structures” Carbon 50 (2012); 4432-4440.

1. A method for controlling microstructural arrangement of nominally-aligned arrays of carbon nanotubes (CNTs), the method comprising:
modifying or controlling mechanical response of CNT arrays after synthesis of CNTs by synthetizing particles in situ in the nominally-aligned arrays of carbon nanotubes (CNTs).

2. The method of claim 1, wherein the particles are nanoparticles synthetized without affecting crystalline structure of CNTs.

3. The method of claim 1, wherein the particles are metal oxide nanoparticles.

4. The method of claim 1, wherein the particles are metal nanoparticles.

5. The method of claim 1, wherein the particles are SnO₂ nanoparticles.

6. The method of claim 1, wherein the particles are MnO₂ nanoparticles.

7. The method of claim 5, wherein synthesis of SnO₂ nanoparticles comprises a kinetically-controlled catalytic synthesis.

8. The method of claim 5, wherein synthesis of SnO₂ nanoparticles results in brittle deposits of oxide in array interstices separated by bundles of CNTs.

9. The method of claim 6, wherein synthesis of MnO₂ nanoparticles comprises a synthesis in-solution of MnO₂.

10. The method of claim 6, wherein synthesis of MnO₂ nanoparticles comprises emersion of the CNTs in aqueous KMnO₄, wherein the MnO₂ nanoparticles form on the individual CNTs themselves.

11. The method of claim 1, wherein the particles are dispersed deep within millimeter-scale arrays.

12. The method of claim 1, wherein the particles comprises Fe oxide.

13. The method of claim 1, wherein the particles comprises Co oxide.

14. The method of claim 1, wherein the CNT arrays are reinforced by coating the individual CNT surfaces.

15. The method of claim 1, wherein the CNT arrays are reinforced by filling the interstices of the arrays with the particles.

16. The method of claim 5, wherein aqueous SnCl₂ precursor is contained in the CNT array using a hydrolyzing agent to cause the precipitation of Sn(OH)Cl that is converted to SnO₂ in a subsequent heat treatment, wherein the CNT array provides a substrate or space to accommodate the SnO₂.

17. The method of claim 16, wherein the hydrolyzing agent is ammonia.

18. The method of claim 6, wherein CNT samples are added to aqueous KMnO₄ with subsequent spontaneous reduction of MnO₄⁻ to MnO₂ on the surface of the CNTs, which act as a reducing agent.

19. A method for controlling microstructural arrangement of nominally-aligned arrays of carbon nanotubes (CNTs), wherein the CNTs have an ordered structure as grown, the method comprising:
modifying mechanical response of arrays of CNTs after synthesis of CNTs by associating a plurality of particles to the arrays of CNTs, wherein the arrangement of CNTs with the particles is an arrangement ordered like or equally to the ordered structure of the CNTs as grown.

20. The method of claim 19, wherein the particles are metal oxide nanoparticles.

21. The method of claim 19, wherein the particles are SnO₂ particles.

22. The method of claim 19, wherein the particles are MnO₂ particles.

23. The method of claim 19, wherein the particles are synthetized in situ in nominally-aligned arrays of CNTs after, a synthesis of CNTs.

24. The method of claim 19, wherein the particles are metal nanoparticles.

25. The method of claim 19, wherein aqueous SnCl₂ is added to the arrays of CNTs with a hydrolyzing agent to cause the precipitation of Sn(OH)Cl, wherein the Sn(OH)Cl is converted to SnO₂ with heat.

26. The method of claim 19, wherein CNT samples are added to aqueous KMnO₄ with subsequent spontaneous reduction of MnO₄⁻ to MnO₂ on the surface of the CNTs, which acted as a reducing agent.

27. A foam structure comprising nominally-aligned arrays of carbon nanotubes (CNTs), wherein:
the foam structure comprises a plurality of particles associated to the nominally-aligned arrays of CNTs; and
the CNTs have an ordered structure as grown, wherein the arrangement of CNTs with particles is an arrangement ordered like or equally to the ordered structure of the CTNs as grown, wherein
a modification of the distribution or number of particles determines a modification of mechanical response of the foam structure.

28. The foam structure of claim 27, wherein the particles are metal oxide nanoparticles.

29. The foam structure of claim 27, wherein the particles are SnO₂ particles.

30. The foam structure of claim 27, wherein the particles are MnO₂ particles.

31. The foam structure of claim 27, wherein the particles are located in interstices among CNTs.

32. The foam structure of claim 27, wherein the particles coat surfaces of CNTs.

33. The foam structure of claim 27, wherein the CNTs have a original crystalline structure as grown, and wherein the CNTs added with the particles have or maintain a crystalline structure equal to the crystalline structure of the CTNs as grown.

34. The foam structure of claim 27, wherein the particles are metal nanoparticles.
